(19) United States
(12) Patent Application Publication
(10) Pub. No.: US 2022/0108816 A1
(43) Pub. Date: Apr. 7, 2022

(54) ARMORED CABLE WITH REDUCED BEND RESISTANCE

(71) Applicant: Southwire Company, LLC, Carrollton, GA (US)

(72) Inventors: Robert Fazio, Carrollton, GA (US); Philip Sasse, Douglasville, GA (US); Brad Pollard, Carrollton, GA (US); Pill Alexander, Carrollton, GA (US)

(21) Appl. No.: 17/491,615

(22) Filed: Oct. 1, 2021

Related U.S. Application Data
(60) Provisional application No. 63/086,919, filed on Oct. 2, 2020.

(51) Int. Cl. H01B 7/00; H01B 7/04; H01B 7/18; H02G 1/08

(52) U.S. Cl. CPC H01B 7/0009; H01B 7/04; H01B 7/226; H02G 1/08; H01B 7/1885

(57) ABSTRACT

Disclosed herein are armored cables having a reduced bend resistance. Armored cables disclosed herein can comprise flexible insulated conductors and demonstrate improved flexibility despite their adjacent and secured arrangement within the armor sheathing and continuous contact along the longitudinal surfaces of the insulated conductors. Methods of installing armored cables are also disclosed herein.

### CROSS REFERENCE TO RELATED APPLICATION

This application is a non-provisional application which claims a benefit of priority to U.S. Provisional Application No. 63/086,919, filed Oct. 2, 2020, which is hereby incorporated herein by reference in its entirety.

### BACKGROUND

Installation of conductors within a building structure to supply power from an electrical panel to electrical fixtures throughout a building structure can be achieved by installing conduit, cable tray, or cable raceway, along the building structure and pulling insulated cables through the same. Alternatively, armored cables comprising insulated conductors in a prearranged set may be incorporated into an electrical installation to avoid the need to pull cables, while retaining the required protection of the cable along the run of conductors between the electrical panel and the fixture. In this manner, armored cable can provide a more efficient installation method. However, bends in conventional armored cable are often difficult to perform manually, and can require additional equipment such as is required for the installation of conduit for pulled conductors.

Thus, it is a purpose of the invention disclosed herein to provide armored cables having a reduced bend resistance to assist installation of cable within a building structure without sacrificing the required strength, crush and impact resistance of the armored cable. Such improvements can reduce the stress on installers during installation process, and reduce the amount of time required for the installation.

Bundles of cables also may be installed simultaneously, either assembled on-site, or preassembled. Bundled cables also may be pulled through conduit, tray, or raceways as mentioned above. Much effort has been spent in reducing the force and effort required to pull cables through conduit during installation. These efforts typically have focused on reducing the coefficient of friction of cable surfaces contacting each the conduit and other cable components within the conduit during installation.

Cable groupings having reduced pull resistance as a group are therefore desired.

### SUMMARY

Disclosed herein are cables comprising a plurality of individual conductors, the cables exhibiting a reduced pulling force, particularly when being pulled into non-linear conduits. In certain aspects, cables disclosed herein can comprise a plurality of flexible conductors. Certain aspects can comprise an armored cable comprising a metallic armor layer, and a flexible insulated conductor within the metallic armor layer. Flexible insulated conductors disclosed herein each can comprise a plurality of conductive strands, each conductive strand comprising a plurality of secondary strands in a bunch configuration, and an insulation layer surrounding the plurality of conductive strands. Armored cables disclosed herein can have a bend resistance less than that of a similarly constructed conventional armored cable. Methods for installing an armored cable are also disclosed herein, and can comprise manually positioning an armored cable comprising three flexible 250 kcmil conductors along a homerun path comprising at least one bend having a bend angle of about 45° or greater using a maximum bending force of less than about 35 lbs, securing the armored cable to a building structure, and terminating a conductor within the armored cable to an electrical fixture within the building structure.

### BRIEF DESCRIPTION OF THE FIGURES

FIG. 1 depicts a perspective view of an armored cable of the invention.

FIG. 2 depicts an axial view of the armored cable of the invention.

FIG. 3 depicts an apparatus used to determine bend resistance of a cable segment.

### DEFINITIONS

To define more clearly the terms used herein, the following definitions are provided. Unless otherwise indicated, the following definitions are applicable to this disclosure. To the extent that any definition or usage provided by any document incorporated herein by reference conflicts with the definition or usage provided herein, the definition or usage provided herein controls.

While compositions and methods are described herein in terms of “comprising” various components or steps, the compositions and methods also can “consist essentially of” or “consist of” the various components or steps, unless stated otherwise. For example, an armored cable consistent with aspects of the present invention can comprise; alternatively, can consist essentially of; or alternatively, can consist of; a plurality of flexible insulated conductors, a bare conductor, and a metallic armor layer.

Several types of characteristic ranges are disclosed in the present invention. When several ranges are disclosed for a single characteristic, it is intended that embodiments of each of the disclosed ranges are also contemplated in combination with every other relevant characteristic and possible range disclosed herein. For example, an armored cable as disclosed herein may have a bend resistance in a range from 25 to 35 lbs, from 20 to 40 lbs, from 15 to 40 lbs, or from 10 to 25 lbs. Separately, embodiments of armored cables described herein can comprise a plurality of insulated conductors comprising from 2 to 5 insulated conductors. With the understanding stated above, a person of skill in the art will understand that embodiments of armored cable comprising a bend resistance in a range from 25 to 35 lbs and 4 insulated conductors (among other combinations) are contemplated by the disclosure of alternatives in the fashion above.

As used herein, the term “stranded” is used to indicate a conductor having a plurality of strands within the conductor. As will be understood by those of skill in the art, stranded conductors can comprise a plurality of strands that are not individually insulated from another, and twisted together in contact along the longitudinal axis of the conductor in electrical contact. Strands of stranded conductors contemplated herein may be solid or comprise multiple filaments or secondary strands. Separately, conductors contemplated herein may not be stranded, i.e., solid. The size of strands in a cable can generally be constant across many different conductor diameters, the number of strands within the conductor increasing with the diameter of the cable (e.g., conductors may have strand layers comprising 1, 7, 19, 37, 61, strands, across 1, 2, 3, 4, 5 layers of strands, respectively. Stranded cables as described herein may further comprise any number of filaments arranged within each strand, again in non-insulated contact along their longitudinal axis to form each strand. The relative nomenclature for conductors, strands, and filaments as described here will be presumed throughout this disclosure, except as explicitly noted to the contrary or as necessary to preserve intended meaning of cable construction.

The term “about” means that amounts, sizes, parameters, and other quantities and characteristics are not and need not be exact, but can be approximate and/or larger or smaller, as desired, reflecting tolerances, conversion factors, rounding off, measurement errors, and the like, and other factors known to those of skill in the art. In general, an amount, size, formulation, parameter or other quantity or characteristic is “about” or “approximate” whether or not expressly stated to be such. The term “about” also encompasses amounts that differ due to different equilibrium conditions for a composition resulting from a particular initial mixture. Whether or not modified by the term “about,” the claims include equivalents to the quantities. The term “about” can mean within 10% of the reported numerical value, preferably within 5% of the reported numerical value.

The terms “a,” “an,” “the,” etc., are intended to include plural alternatives, e.g., at least one, unless otherwise specified. For instance, the disclosure of “a flexible insulated conductor” or “a conductor strand” is meant to encompass one, or combinations of more than one, flexible insulated conductor or conductor strand, respectively, unless otherwise specified.

### DETAILED DESCRIPTION

Armored cables are disclosed herein comprising a reduced bend resistance to assist manipulation of the cables during installation compared to conventional armored cables comprising stranded and solid metal conductors. Installation methods benefiting from the reduced bend resistance are also contemplated herein.

Armored cables contemplated herein generally can comprise an external armor sheathing providing protection to interior cable components. The armor sheathing can be metallic or non-metallic. The shape of the armor sheathing is not limited to any particular shape, and can be any that provide a suitable crush and impact resistance to the cable. In certain aspects, the armor can comprise a helically wrapped metal sheathing. Armored cables contemplated herein can comprise a plurality of conductors present as a conductor core within the armor layer. The conductor core can comprise any number of conductors suitable and appropriate to supply power between an electrical panel and fixture. In certain aspects the armored cable can comprise three insulated conductors and a bare grounding conductor. In other aspects the armored cable can comprise four insulated conductors and a bare ground conductor. The insulated conductors can be any size, e.g., 1, 1/0, 2/0, 3/0, or AWG 4/0, or 250 kcmil, 350 kcmil, 500 kcmil, 600 kcmil, or 750 kcmil. The insulated conductors can be the same or different sizes. The ground conductor can typically be somewhat smaller than the insulated conductors of an armored cable, and can be a 6, 4, 3, 2, 1, 1/0, 3/0, 4/0 AWG or 250 kcmil conductor. Additional alternatives and combinations are contemplated herein as would be understood by a person of ordinary skill.

Optionally, armored cables contemplated herein can comprise a bare ground conductor adjacent at least one insulated conductor within the armored cable. The optional ground conductor can be included within, or excluded by a tape separator surrounding conductive elements of the armor cable interior. In certain embodiments, the armored cable can comprise two insulated conductors surrounded by a tape separator and a bare ground conductor adjacent the outer face of the tape separator. Alternatively, the tape separator can encircle each of the plurality of insulated conductors and an optional bare ground conductor.

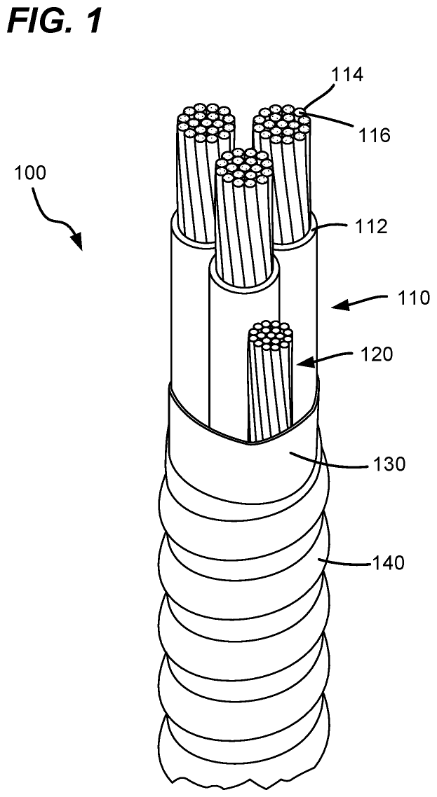

The construction of insulated conductors within the armored cable is not limited to any singular construction, and can generally be any which enable the armored cable product to exhibit the bend reduction as demonstrated and disclosed herein. In certain aspects, the insulated conductors contemplated herein can comprise a series of strands, each strand comprising a series of filaments twisted together in a tight grouping. In such aspects, the insulated conductors can comprise any number of strands. For instance, in certain aspects the flexible insulated conductor can comprise from 7 to 128 conductive strands. The conductive strands may be arranged in any configuration within the insulated conductor. For instance, in an embodiment comprising a 19-stranded insulated conductor, the strands can be arranged in a 1+6+12 configuration as is shown in FIG. 1.

Moreover, to afford the insulated conductor flexibility, each conductive strand can be constructed of a number of filaments, or secondary strands, as opposed to each conductive strand represented as a solid drawn wire as in conventional cables. Secondary strands, or filaments suitable for construction of the flexible strands are not limited to any particular shape or size, but it is believed generally rounded shape can provide a flexible strand. Without being bound by theory, the rounded shape may retain some degree of interstitial space to persist between each filament, thereby allowing the filaments to flex more easily under bending force. In certain aspects, conductive strands suitable for flexible insulated conductors contemplated herein can comprise a diameter in a range from 0.05 to 0.5 inches, from about 0.05 to about 0.25 inches, from about 0.1 to 0.15 inches. Additionally, the conductive strands may have any number of filaments within each strand to allow desired flexibility of the insulated conductor. In some aspects, conductor strands can comprise from about 20 to about 200 filaments, from about 20 to about 100 filaments, or from about 25 to about 50 filaments. Accordingly, it can be seen that a total number of filaments within the flexible conductor can range from about 140 (e.g., in a flexible conductor comprising 7 strands in a 1+6 configuration, each strand comprising 20 filaments) to about 25,000 filaments (e.g., in a flexible conductor comprising 128 wires each having about 200 filaments). Alternatively, the number of filaments in certain aspects can be within a range from about 150 to about 10,000, from about 150 to about 5,000, or from about 150 to about 2500.

The flexible insulated conductors contemplated herein can comprise filaments arranged in any manner within each strand, but generally are arranged adjacent in direct contact. In certain aspects, the filaments can be twisted together having a constant twist in a range from about 1 to about 10 degrees relative to the axis of the strand. Strands within insulated conductors can comprise bunch-stranded filaments. In certain aspects the filaments can be stranded according to Class K stranded wire comprising 30 AWG copper wires. In other aspects, conductor strands can comprise Class I stranded wires. In certain aspects the cable can comprise a flexible insulated cable such as provided by Southwire® as Machine Flexible Power cable.

Configurations of flexible insulated conductors as described herein may allow production of wide range of conductor sizes. Conductors contemplated as flexible under the constructions disclosed herein include zines in a range from 8 AWG to 4/0 AWG, and 250 kcmil to 1000 kcmil cables. Typically, the amount of conductor strands within a cable can scale according to the size of the conductor. Accordingly, as conductors comprising a number of strands in a range from 7 to 128, larger conductors may comprise strands in a range from about 65 to 128, whereas smaller conductors may comprise strands in a range from about 7 to about 37 strands. Similarly, the number of filaments within the conductor may scale as well.

Generally, the flexible insulated conductors, and optional bare conductor, can comprise any material suitable for the transmission of power. For instance, conductor strands and filaments may comprise copper, aluminum, steel, or combinations and alloys thereof. Similarly, the composition of the insulation layer is not limited to any particular insulation, and may be any suitable to limit electrical grounding across the insulation layer of the conductor and provide structural integrity to the conductor without unduly increasing the bend resistance of individual conductors.

An embodiment of an armored cable of the present invention is depicted by FIG. 1. As shown by FIG. 1, armored cable 100 includes flexible insulated conductors 110 and bare ground conductor 120 within tape separator 130 to separate the conductor core from armor sheathing 140. Armor sheathing 140 is metallic in the embodiment shown by FIG. 1, and helically wrapped armored sheathing in contact with the tape separator. Other embodiments are contemplated herein having the optional bare conductor outside the tape separator and in direct contact with the metallic sheathing along the length of the cable. Each of the flexible insulated conductors 110 comprises an insulation layer 112 surrounding a stranded conductor core comprising 19 individual conductor strands 114. As discussed above, each conductor strand 114 further comprises 33 filaments as a twisted in arrangement as a bunch stranded configuration. Insulation layer 112 comprises polyvinylchloride and an outer nylon sheathing.

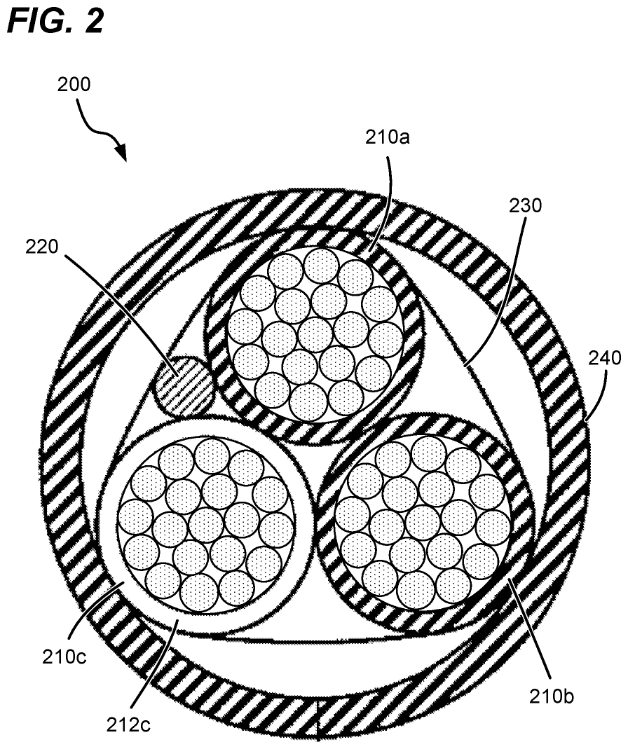

FIG. 2 shows a slightly different embodiment of the invention disclosed herein in an axial view. Armored cable 200 also comprises three flexible insulated conductors 210a-c having the same configuration of strands and filaments within the strands. As for the embodiment of FIG. 1, Filaments are again represented as stippling within the conductor strand in generally even arrangement within the strand, with each strand generally adjacent in a compact bunch stranded configuration. The embodiment of FIG. 2 also comprises a ground conductor within the tape separator, positioned adjacent two of the three flexible insulated conductors. It is also shown in FIG. 2 that the flexible insulated conductors can be the same or different within the cable. As discussed above, any combination of insulated conductors suitable for an electrical application is generally within the scope of this invention, and contemplated herein. Insulation layer of conductor 210c is depicted with no shading compared to two other insulated conductors to indicate differential insulation layers between the cables. In certain cables may have two positive cables and a common neutral with somewhat different insulating characteristics and appearance.

Surprisingly, armored cables constructed as described above demonstrate a reduced bend resistance despite the presence of the protective armor layer. In certain aspects, the armored cables can exhibit a bend resistance in a range from about 5 lbs to about 500 lbs, from about 10 to about 250 lbs, from about 25 to about 200 lbs, from about 5 lbs to about 100 lbs, from about 5 to about 50 lbs, from about 10 lbs to about 40 lbs, from about 15 lbs to about 35 lbs, from about 20 lbs to about 30 lbs, from about 15 lbs to about 30 lbs, or from about 20 to about 25 lbs. Alternatively, armored cables disclosed herein can have a bend resistance of less than about 5 lbs, less than about 10 lbs, less than about 20 lbs, less than about 25 lbs, less than about 35 lbs, less than about 50 lbs, less than about 100 lbs, or less than about 250 lbs.

Bend resistance of a given armored cable may vary significantly for armored cables comprising different amounts and sizes of conductors. In certain aspects, the armored cable disclosed herein can have a bend resistance that is less than that of an analogous armored cable comprising an equivalent amount and size of conventional non-flexible insulated conductors. Non-flexible insulated conductors may differ from flexible conductors by having a much lower number of strands within each conductor, and/or a much high average strand diameter. In this manner, it can be seen that a 1+6+12 strand configuration in a conventional non-flexible conductor can comprise a solid copper wire strand for each of the 19 strands. The non-flexible conductor strands will have a strand diameter of about ⅛″ in a 250-kcmil conductor. In contrast, the flexible insulated conductors included within the armored cables disclosed herein can comprise a much lower average strand diameter due to each of the 19 bunch strands consisting of 33 individual strands. Thus, the average strand diameter for insulated conductors employing a bunch strand configuration can be much less than a conventional solid strand configuration, in this example on the order of 1/64″.

In certain aspects, armored cables disclosed herein can have a bend resistance less than 80%, less than 70%, less than 60%, less than 50%, or less than 40% that of a similarly constructed armored cable having a solid stranded configuration.

Required installation pulling force of cables disclosed herein also can be reduced relative to armored cables comprising conventional stranded conductors. Efforts to reduce pulling force have focused on providing a layer of lubrication to the exterior of the cable to reduce the coefficient of friction between the exterior of the cable and the conduit sidewall, thereby allowing the cable to smoothly transfer along on the conduit. For instance, U.S. Pat. No. 11,011,285, hereby incorporated herein by reference, describes electrical cables configured to allow a lubricant to continually migrate from the interior of an extruded cable jacket to the exterior surface of the cable, after manufacture. Efforts to reduce the pulling force of armored cables limited to on site application of lubricant to the armored cable and development of low-profile armored cable designs with potential to limit crush resistance of the cable.

However, resistance to the installation pulling force on cables is also exerted by the sidewall pressure applied to the cable as it maneuvers about bends in the conduit. Excessive side wall pressure can cause cable damage, and can be the most restrictive factor in many installations. Armored cables disclosed herein comprising flexible conductors were found to reduce the pulling tension according to the reduced bend resistance, particularly when pulled through conduits with multiple or sharp bends. In certain aspects, the required installation pulling force can be reduced to 95%, 90%, 85%, 80%, 75%, 60%, 50%, 40%, 30%, or 25% that of an otherwise identical cable comprising conventional stranded or solid conductors. Surprisingly, the reductions in pulling force can be well in excess of that observed by a similar lubricated conductor. Pull tests were conducted using both lubricated cables and flexible cables.

Flexible insulated cables suitable for the armored cables disclosed herein can have a strand to conductor ratio describing the relationship between the total conductor diameter and the number of strands (including secondary strands, e.g., filaments) within the conductor. In certain aspects, the strand to conductor ratio can be in a range from about 500 to 5,000, from about 1,000 to about 2,000, or from about 500 to about 2,500. In other aspects, the strand to conductor diameter ratio can be greater than 250, greater than 500, greater than 1,000, or greater than 2,000. Conventional conductors may be limited to a ratio less than 100, less than 50 or less than 25.

Advantages of armored cables disclosed herein are apparent in installation procedures, where the armored cables are required to be bent to configure to the shape of building structures. Methods of installing are also contemplated herein comprising manually positioning an armored cable along a homerun path comprising at least one bend having a bend angle of about 45° or greater using a maximum bending force of less than about 35 lbs, securing the armored cable to a building structure, and terminating a conductor within the armored cable to an electrical fixture within the building structure. Positioning the armored cable also can comprise using a maximum bending force less than that required to bend a conventional armored cable as described above (e.g., 90% less, 80% less, 75% less, 65% less, 55% less, 50% less).

The installation path, or homerun path, between the electrical panel and fixture may have any number and degree of bends, as would be understood by a person of ordinary skill in the art. Accordingly, the armored cable described herein provides advantage to the installation of each bend by reduction of manual force required, and in certain cases allowing the installation of even larger armored cables to be completed without the use of additional specialized bending tools.

### Examples

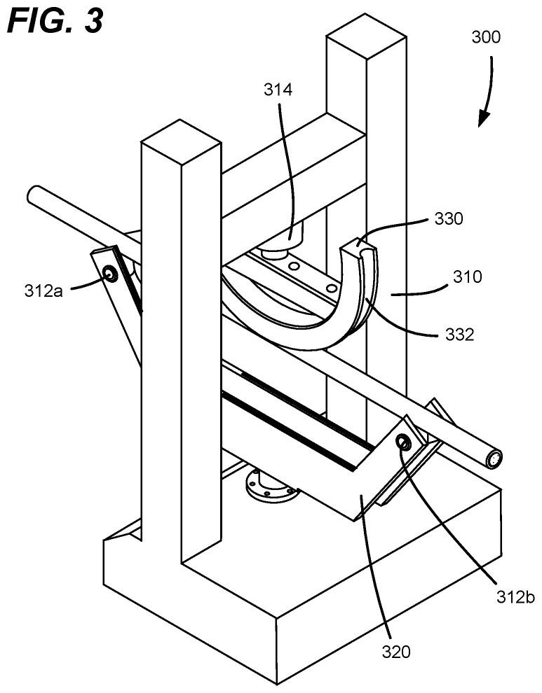

Bend resistance for cable segments comprising flexible insulated conductors and conventional insulated conductors was measured as follows. FIG. 3 depicts a bend apparatus 300 constructed to perform the bend resistance analysis. Bend apparatus 300 includes a support frame 310 and cable support 320 comprising support rollers 312a,b positioned 46 inches apart. Support rollers 312 provide support to cable segment toward opposite ends of the cable segment. A bending sheave 330 having a bend diameter of 28 inches is positioned above the horizontal plane defined by the support rollers, and aligned to contact the armor layer of the cable segment at a center point between the support rollers, within bending channel 332. Bending sheave 330 is attached to support frame 310 by piston 314 configured to advance the bending sheave downward at a constant speed. In this manner, the bending sheave was positioned to apply a downward bending force perpendicular to the longitudinal axis of the armored cable as supported by the support rollers. After loading the armored cable segment onto the support rollers, the bending sheave was advanced downward along a linear bend path, again perpendicular to the cable axis. The bending sheave was advanced from its starting point at a rate of 2 inches per minute for 6 minutes, across a total of 12 inches. A bend resistance force during the bend was determined as the differential resistance force applied to the bending sheave by the armored cable as the cable was bent.

TABLE 1
Conventional MC 250/3

| Example # | Peak (lbs) |
|---|---|
| 1-1 | 42.7 |
| 1-2 | 43.0 |
| 1-3 | 48.2 |
| 1-4 | 36.4 |
| 1-5 | 47.4 |
| Mean | 43.5 |

TABLE 2
Flexible MC 250/3

| | Maximum bend |
|---|---|
| Example # | resistance (lbs) |
| 2-1 | 21.8 |
| 2-2 | 23.0 |
| 2-3 | 20.9 |
| 2-4 | 20.2 |
| 2-5 | 18.9 |
| Mean | 21.0 |

Armored cables comprising flexible stranded conductors and conventional copper conductors were analyzed according to the test described above. Five cable segments of each cable were prepared in approximately six-foot lengths. Each armored cable consisted of a conductor core having three 250-kcmil conductors and a solid 2 AWG ground conductor in direct contact with the metallic armor layer. Bend tests were performed on each of the armored cable segments, and according to the results below. Notably, the peak bend resistance for each cable segment was achieved at a midpoint in the bend, such that the bend resistance was decreasing as the bending sheave reached its endpoint (i.e., 12″ bend path endpoint).

As shown by Tables 1-2 above, the average maximum bend resistance across flexible MC segments was 21.0 lbs, compared to more than double that for the conventional armored cable (43.5 lbs bend resistance force). Surprisingly, flexible conductors arranged within the armored cable, and in direct and secure contact with each other and the armor layer, demonstrated a reduction in bend resistance of more than 50% compared to the armored cable comprising conventional conductors. The observed reduction in bend resistance is surprising at least for the ability of the conductors constrained within the armored cable to be bent while lateral position of the cable components is maintained relative to one another, and without allowing significant axial displacement based on their arrangement within the metal sheathing. Moreover, this reduction in bend resistance is beyond that which would be expected based on the difference in bend resistance for the summed combination of individual conductors compared to conventional conductors.

What is claimed is:

1. An armored cable comprising:
a metallic armor layer; and
a flexible insulated conductor within the metallic armor layer, the flexible insulated conductor comprising:
a plurality of conductive strands, each conductive strand comprising a plurality of secondary strands arranged in a bunch configuration; and
an insulation layer surrounding the plurality of conductive strands;
wherein the flexible insulated conductor has a secondary strand to conductor diameter ratio in a range from 500 to 5,000; and
wherein the armored cable has a bending resistance less than that of an otherwise identical armored cable with an insulated conductor having a strand to conductor diameter ratio of less than 100 instead of the flexible insulated conductor.

2. The armored cable of claim 1, wherein the bend resistance is less than 50% that of a similarly constructed armored cable comprising an insulated conductor having a strand to conductor diameter ratio of less than 100.

3. The armored cable of claim 1, wherein the stranded conductor comprises a stranded bare copper conductor.

4. The armored cable of claim 1, wherein the stranded conductor is arranged in a 1+6+12 pattern.

5. The armored cable of claim 1, wherein the armored cable comprises a plurality of insulated conductors.

6. The armored cable of claim 1, wherein each of the plurality of insulated conductors is an 8-4/0 AWG conductor.

7. The armored cable of claim 1, wherein the armored cable further comprises a bare ground conductor.

8. The armored cable of claim 1, wherein the armored cable comprises three insulated conductors and a bare ground conductor.

9. The armored cable of claim 1, wherein the armored cable comprises a conductor core consisting of three flexible insulated conductors and a bare ground conductor.

10. The armored cable of claim 9, further comprising a tape separator surrounding the conductor core.

11. The armored cable of claim 1, wherein the flexible insulated conductor is a type THHN or THWN conductor.

12. The armored cable of claim 1, wherein the insulation layer comprises polyvinylchloride.

13. The armored cable of claim 1, wherein the flexible insulated conductor further comprises an outer sheath surrounding the insulation layer, and wherein the outer sheath comprises nylon.

14. The armored cable of claim 13, wherein the outer sheath further comprises a lubricant.

15. The armored cable of claim 1, wherein the flexible insulated conductor comprises from 7 to 128 conductive strands.

16. The armored cable of claim 1, wherein each of the plurality of conductive strands comprises from about 15 to about 150 secondary strands.

17. The armored cable of claim 1, wherein the flexible insulated cable comprises 19 conductive strands, each comprising 33 secondary strands.

18. The armored cable of claim 1, wherein a pulling force required to pull the cable through a building passageway comprising at least two 90° bends within the PVC conduit setup is less than 75% that of an otherwise identical armored cable with an insulated conductor having a strand to conductor diameter ratio of less than 100 instead of the flexible insulated conductor.

19. A method for installing an armored cable, the method comprising:
manually positioning the armored cable of claim 1 along a homerun path comprising a bend having a bend angle of about 45° or greater using a maximum bending force of less than about 35 lbs;
securing the armored cable to a building structure; and
terminating a conductor within the armored cable to an electrical fixture within the building structure.

20. The method of claim 19, wherein the homerun path comprises the bend has a bend angle of about 90° or greater.
